(19) United States
(12) Patent Application Publication
(10) Pub. No.: US 2001/0029755 A1
(43) Pub. Date: Oct. 18, 2001

(54) Method of forming an alignment marker for optical devices

(76) Inventors: Hiromi Takahashi, Tokyo (JP); Hideki Ono, Tokyo (JP)

Correspondence Address: VENABLE, Post Office Box 34385, Washington, DC, 20043-9998, US

(21) Appl. No.: 09/739,621

(22) Filed: Dec. 20, 2000

(30) Foreign Application Priority Data
Apr. 12, 2000 (JP) 2000-110816

(51) Int. Cl. C03B 37/022

(52) U.S. Cl. 65/386

(57) ABSTRACT

A first layer to be processed later into a core is formed on a substrate. Next on the first layer, a mask layer and an alignment marker are formed within a core forming area and an alignment marker forming area, respectively. The alignment marker, which is used as a marker for groove processing, is covered with a protective layer. The protective layer is made so as to have a width larger than that of the alignment marker, and is made of an optically transparent material. The first layer is etched while being masked with the mask and protective layers. The mask layer is then removed to thereby leave a core. The structure thus obtained by the above processes is entirely covered with a second layer which later functions as a clad. Detection of the alignment marker is effected by optically sensing the edge thereof. The conventional problem is thus successfully solved that the edge of the alignment marker cannot be detected and thus the alignment for the groove processing remains impractical.

### BACKGROUND OF THE INVENTION

1. Field of the Invention

The present invention relates to a method of forming an alignment marker for optical devices, and in particular to a method of forming an alignment marker using a processing marker for a filter insertion groove provided together with a light guide for wavelength division multiplexing (WDM) devices.

2. Description of the Background Art

An optical waveguide for wavelength division multiplexing (WDM) devices has been described in IEICI (The Institute of Electronics, Information and Communication Engineers) Transactions of Electronics Society Conference, C-168, 1996. The WDM optical waveguide described in the literature has a filter disposed in the middle thereof so as to separate 1.3 μm wavelength from 1.5 μm wavelength. The filter is adapted to reflect only the 1.5 μm wavelength, where the 1.3 μm wavelength corresponds to an audio signal and the 1.5 μm wavelength to an image signal.

Conventionally, a groove in which the filter is inserted has been processed using a dicing apparatus. Positional accuracy of such a groove has thus been governed by a relative, positional accuracy between a groove processing marker positioned on a substrate and a core of the optical waveguide.

FIGS. 1A, 1B and 1C show processes in a conventional method of forming an alignment marker for groove processing. As illustrated in FIG. A, a layer 20 which is later processed into a core of a light guide is formed on one major surface 12 of a substrate 10. Next, on the core-forming layer 20, a mask layer 30 is formed within a core forming area, and analignmentmarker40 for groove processing is formed within a groove processing marker forming area.

Next, as shown in FIG. 1B, the core-forming layer 20 is then etched while being masked with the mask layer 30 and the groove processing marker 40.

Successively, as shown in FIG. 1C, the mask layer 30 is removed to thereby produce a core 60 composed of a residual portion-of the layer 20. A clad 70 is then formed on the entire surface 12. The position of the edge A of the groove processing marker 40 is detected in that state.

A problem, however, resides in the foregoing alignment method using the groove processing marker 40 that light for use in detecting the position of the edge A of the groove processing marker 40 is scattered at the slope B of the clad 70, which prevents the edge A of the groove processing marker 40 from being detected and thus makes the alignment for the groove processing impractical.

### SUMMARY OF THE INVENTION

It is therefore an object of the present invention to provide a method of forming an alignment marker for groove processing allowing accurate alignment.

In accordance with the present invention, a method of forming an alignment marker for optical devices comprises the steps of: preparing a generally flat substrate; forming, on a major surface of the substrate a first layer which is later processed into a core of a light guide; forming on the first layer a mask layer within a core forming area, and an alignment marker within an alignment marker forming area; covering the alignment marker with an optically transparent protective layer; etching the first layer while being masked with the mask layer and protective layer; removing the mask layer; and covering an entire structure obtained in the above steps with a second layer which is later functions as a clad layer; the protective layer having a width in a direction substantially parallel to the major surface larger than a width of the alignment marker.

### BRIEF DESCRIPTION OF THE DRAWINGS

The objects and features of the present invention will become more apparent from the consideration of the following detailed description taken in conjunction with the accompanying drawings in which:

FIGS. 1A, 1B and 1C show in cross-sectional views processes in a conventional method of forming a groove processing marker;

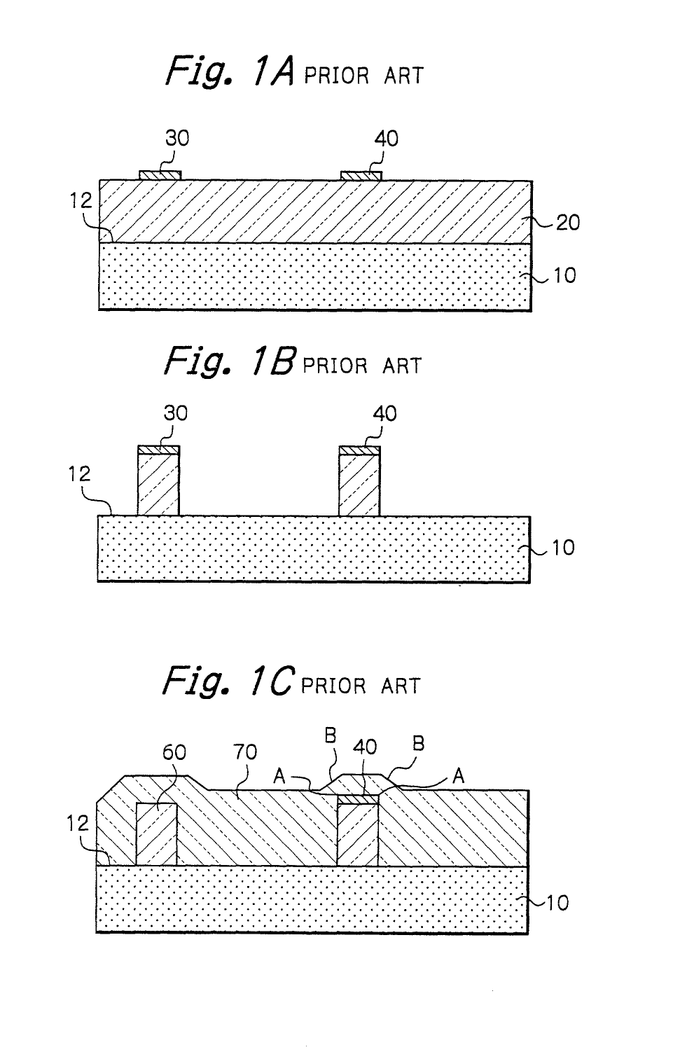

FIGS. 2A to 2D show in cross-sectional views, taken in a direction substantially normal to the longitudinal direction of a light guide, processes in a method of forming an alignment mark for groove processing according to an embodiment of the present invention;

FIGS. 3A to 3E show in cross-sectional views, taken similarly to FIGS. 2A to 2D, processes in a method according to another embodiment of the present invention; and

FIGS. 4A to 4D show in cross-sectional views, taken similarly to FIGS. 2A to 2D, processes in a method according to still another embodiment of the present invention.

### DESCRIPTION OF THE PREFERRED EMBODIMENTS

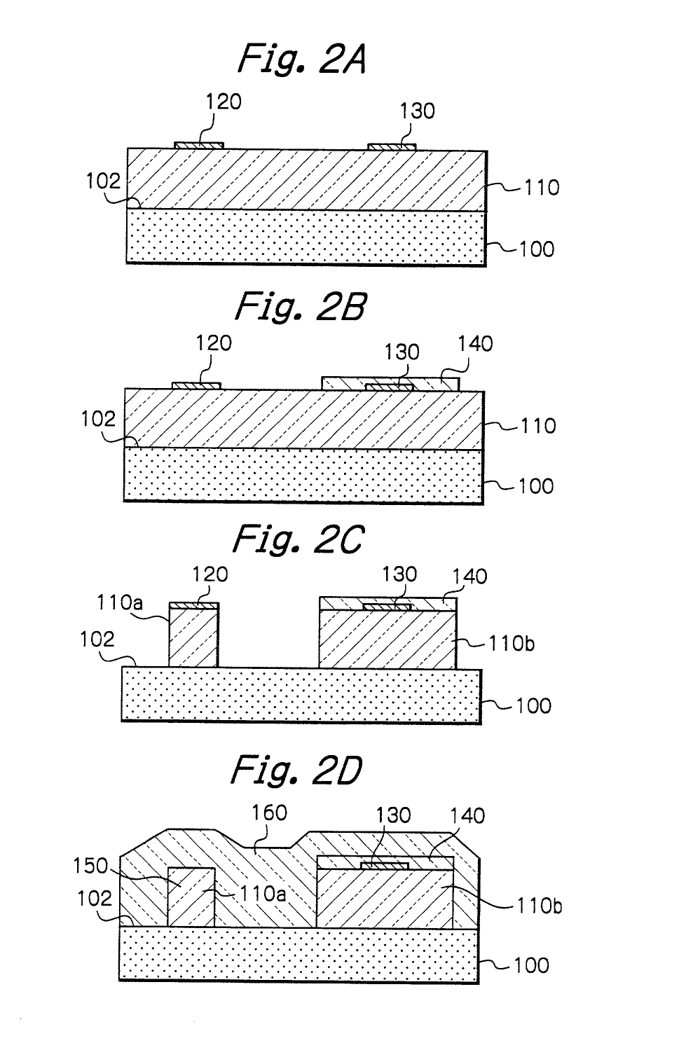

Specific embodiments of the present invention are detailed hereinafter referring to the drawings. FIG. 2A to 2D show in cross-sectional views processes in a method of forming an alignment marker for groove processing according to an embodiment of the present invention. This embodiment is advantageously applicable to a formation process of a filter used in a WDM light guide device.

As shown in FIG. 2A, on one major surface 102 of a generally flat substrate 100 made of semiconductor material, such as silicon, a layer 110 is formed which will later be processed into a core of a light guide. On the layer 110, a mask layer 120 is formed within a core forming area, and an alignment marker 130 is formed within an alignment marker forming area. The alignment marker 130 is spaced by a predetermined distance from the position of the mask layer 120 where the core will later be formed, and is used later as an alignment marker for groove processing. The layer 110 herein is made of Ga-doped SiO₂, and the alignment marker 130 is made of WSi, for example.

Next, the alignment marker 130 is covered with a protective layer 140 as shown in FIG. 2B. The protective layer 140 is made so as to have a width in the direction substantially parallel to the major plane 102, that is, in the horizontal direction in the figure, larger than the width of the alignment marker 130. The protective layer 140 is made of an optically transparent material.

Successively, as shown in FIG. 2C, the layer 110 is etched while being masked with the mask layer 120 and the protective layer 140, whereby the portions of the layer 110 are removed other than masked portions 110a and 110b.

Then, as shown in FIG. 2D, the mask layer 120 is removed so that the masked portion 110a remains which will function as a core 150. The structure thus obtained is then entirely covered with another layer 160. Detection of the alignment marker 130 is effected by optically sensing the edge thereof.

As is clear from the above, since this embodiment employs the protective layer 140 larger in width than the alignment marker 130, the edge of the alignment marker 130 and the slope of the layer 160 later which will function as a clad can be located apart from each other in the direction substantially parallel to the major surface 102 of the substrate 100. The edge of the alignment marker 130 can successfully be detected without being bothered with the conventional problems that the light is laterally scattered at the edge of the layer 160 which will later function as a clad and that the alignment for the groove processing thus remains impractical.

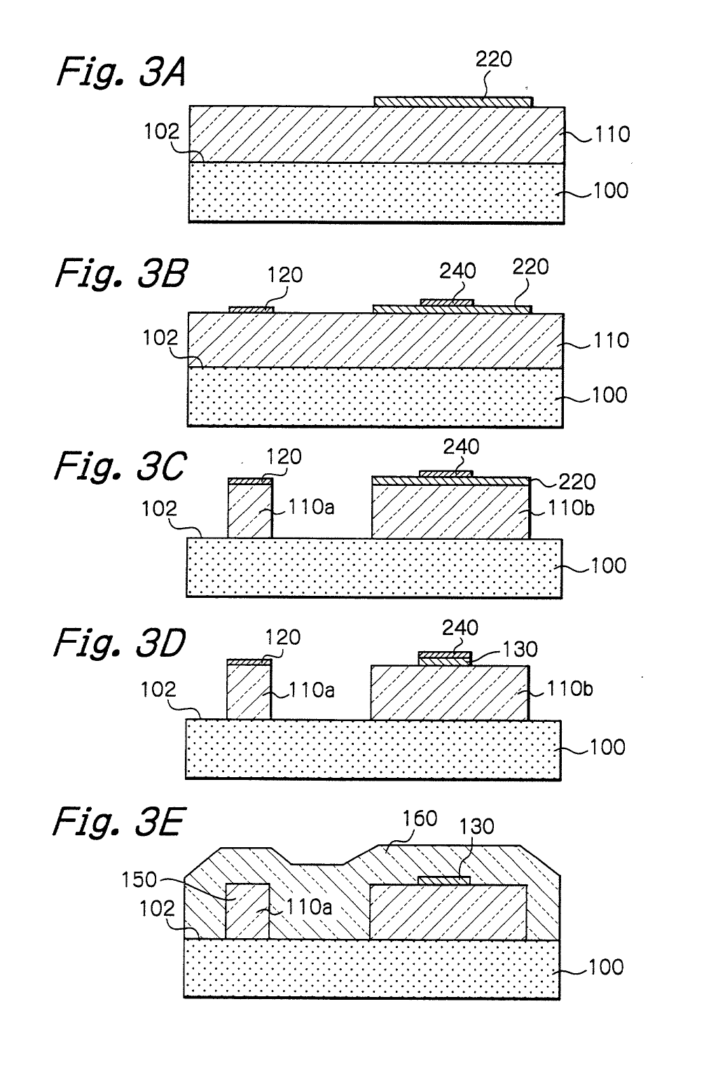

FIGS. 3A to 3E show in cross-sectional views processes for an alternative embodiment of the present invention. In these figures, elements like those in FIGS. 2A to 2D are designated with the same reference numerals. As shown in FIG. 3A, on the substrate 100 made of, for example, silicon, a layer 110 is formed which will later be processed into a core. On the layer 110, a mask layer 220 is formed within an alignment marker forming area. The mask layer 220 is now made using, for example, WSi so as to have a width larger enough in the horizontal direction in the figure than that of the alignment marker 130 to be formed.

Next, as shown in FIG. 3B, another mask layer 120 is formed on the layer 110 within the core forming area, and still another mask layer 240 is formed on the mask layer 220 within the alignment marker forming area. The mask layer 240 is formed so as to have a width equal to that of the alignment marker 130 to be formed. Next, as shown in FIG. 3C, the layer 110 is etched while being masked with the mask layers 120 and 220, to thereby leave masked portions 110a and 110b.

Then, as shown in FIG. 3D, the mask layer 220 is etched while being masked with the mask layer 240, so that the portions other than an underlying portion 130 are removed. Following this, as shown in FIG. 3E, the mask layers 230 and 240 are removed. The masked portion 110a thus remains as a core 150. The structure thus obtained is then entirely covered with another layer 160 later functioning as a clad. The underlying portion 130 coming from the mask layer 220 remaining after the etching is used as an alignment marker.

As is clear from the above, since this embodiment employs the mask layer 220 larger in width than the alignment marker (underlying portion 130), the edge of the alignment marker and the slope of the layer 160 which will function as a clad can be located apart from each other in the horizontal direction.

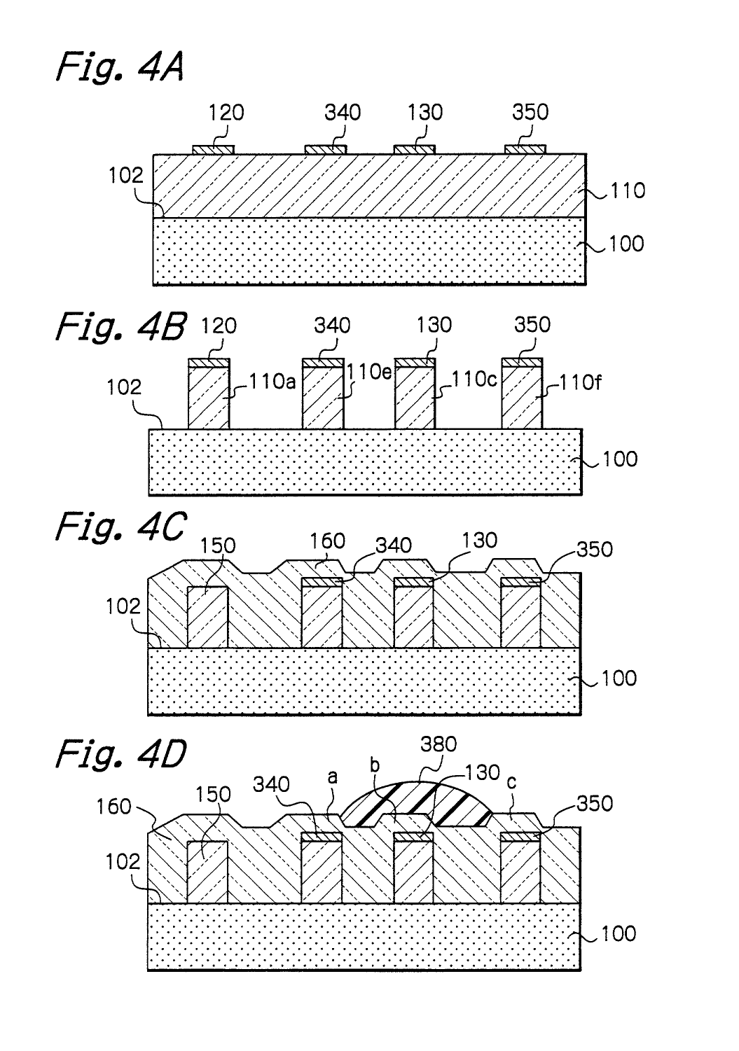

FIGS. 4A to 4E show in cross-sectional views processes for a further alternative embodiment of the present invention. As shown in FIG. 4A, on the substrate 100 made of, for example, silicon, a layer 110 which will later be processed into a core is formed. On the layer 110, a mask layer 120 is formed within a core forming area. Within an alignment marker forming area on the layer 110, an alignment marker 130 and two mask layers 340 and 350 are formed so that the mask layers 340 and 350 are located on both sides of the alignment marker 130. The mask layers 340 and 350 may be formed using the same material as that for the mask layer 120.

Subsequently, as shown in FIG. 4B, the layer 110 is etched while being masked with the alignment mark 130 and three mask layers 120, 340 and 350 to thereby leave masked portions 110c, 110a, 110e and 110f, respectively. Thereafter, as shown in FIG. 4C, the mask 120 is removed. The masked portion 110a thus remaining will later function As the core 150. The structure thus obtained is then entirely covered with another layer 160 which will later function as a clad.

Next, as shown in FIG. 4D, on the raised portions or projections a, b and c of the surface of the layer 160 as corresponding to the alignment marker 130, mask layer 340 and mask layer 350, respectively, a resin layer 380 is formed so as to cover the slopes of the layer 160 between the projections a and b and between projections b and c. The resin layer 380 is optically transparent and has a refractive index nearly equal to that of the layer 160. The resin layer 380 herein is made of, for example, an ultraviolet curing resin. The resin layer 380 is formed by printing or discharging from a dispenser, and cured with ultraviolet irradiation. The projections or hills a and c can dam up the resin flow caused by the printing or dispensing.

Detection of the alignment marker 130 is performed by optically sensing the edge under the projection b of the layer 160. The alignment marker 130 is used as a groove processing marker.

The above-described embodiment employs the resin layer 380 on the slope of the layer 160 using a material nearly equal to the layer 160 in the refractive index, so that it is avoidable that an optical interface causative of scattering the incident light is formed between the layer 160 and the resin layer 380.

As has been described in the above, the alignment marker formed according to the present invention can successfully solve the conventional problem that the edge of the alignment marker cannot be detected and thus the alignment for the groove processing remains impractical.

Although the embodiments have been described in conjunction with applications to WDM optical waveguide devices, the present invention is by no means limited thereto, but can advantageously be applied to any method in which an optical alignment marker is formed as spaced by a predetermined distance from a reference position. It is to be appreciated that those skilled in the art can change or modify the embodiments without departing from the scope and spirit of the present invention.

The entire disclosure of Japanese patent application No. 2000-110816 filed Apr. 12, 2000, including the specification, claims, accompanying drawings and abstract of the disclosure is incorporated herein by reference in its entirety.

What is claimed is:

1. A method of forming an alignment marker for optical devices, comprising the steps of:
preparing a generally flat substrate;
forming on a major surface of the substrate a first layer which is later processed into a core of a light guide;
forming on the first layer a mask layer within a core forming area, and an alignment marker within an alignment marker forming area;
covering the alignment marker with an optically transparent protective layer;
etching the first layer while being masked with the mask layer and the protective layer;
removing the mask layer; and
covering an entire structure obtained in said steps with a second layer which later functions as a clad layer;
the protective layer having a width in a direction substantially parallel to the major surface larger than a width of the alignment marker.

2. The method according to claim 1, wherein the light guide is intended for use in a light guide device for wavelength division multiplexing, and the alignment marker is intended for use as a groove processing marker for forming a filter of the device.

3. A method of forming an alignment marker for optical devices, $$comprising the steps of:
preparing a generally flat substrate;
forming on a major surface of the substrate a first layer which is later processed into a core of a light guide;
forming on the first layer a first mask layer within an alignment marker forming area;
forming a second mask layer within a core forming area on the first layer, and a third mask layer on the first mask;
etching the first layer using the first and second mask layers;
etching the first mask layer using the third mask layer;
removing the second and third mask layers; and
covering an entire structure obtained in said steps with a second layer which later functions as a clad layer;
said first mask layer having a width in a direction substantially parallel to the major surface larger than a width of the alignment marker.

4. The method according to claim 3, wherein the light guide is intended for use in a light guide device for wavelength division multiplexing, and the alignment marker is intended for use as a groove processing marker for forming a filter of the device.

5. A method of forming an alignment marker for optical devices, comprising the steps of:
preparing a generally flat substrate;
forming on a major plane of the substrate a first layer which is later processed into a core of a light guide;
forming on the first layer a first mask layer within a core forming area, and an alignment marker within an alignment marker forming area and a second and a third mask layer located on both sides of the alignment marker;
etching the first layer while being masked with the first mask layer, second mask layer, third mask layer and alignment marker;
removing the first mask layer;
covering an entire structure obtained in said steps with a second layer which later functions as a clad layer; and
covering a surface area of the second layer between the second and third mask layers with an optically transparent resin layer having a nearly equal refractive index with a refractive index of the second layer.

6. The method according to claim 5, wherein the light guide is intended for use in a light guide device for wavelength division multiplexing, and the alignment marker is intended for use as a groove processing marker for forming a filter of the device.

7. The method according to claim 5, wherein the resin layer is made of an ultraviolet curing resin.

8. The method according to claim 5, wherein the resin layer is formed by printing or discharging from a dispenser.

9. The method according to claim 5, wherein the second layer has projections over the second and third mask layers for preventing the resin from being flown out while being applied on the second layer.
